(19) United States
(12) Patent Application Publication
(10) Pub. No.: US 2026/0169631 A1
(43) Pub. Date: Jun. 18, 2026

(54) MEMORY MANAGEMENT METHOD AND MEMORY CONTROLLER

(71) Applicant: Hefei Kaimeng Technology Co., Ltd., Anhui (CN)

(72) Inventors: Yuecong Liang, Anhui (CN); Tsung-Lin Wu, Anhui (CN); Qiao ZHU, Anhui (CN); Zhi WANG, Anhui (CN); PengPeng Qin, Anhui (CN); Yu Zhang, Anhui (CN)

(73) Assignee: Hefei Kaimeng Technology Co., Ltd., Anhui (CN)

(21) Appl. No.: 19/387,521

(22) Filed: Nov. 12, 2025

(30) Foreign Application Priority Data
Dec. 12, 2024 (CN) 202411832055.9

(51) Int. Cl. G06F 3/06

(52) U.S. Cl. CPC G06F 3/0613; G06F 3/064; G06F 3/0679

(57) ABSTRACT

The present disclosure provides a memory management method and a memory controller. The method comprises: obtaining a block usage status of a plurality of physical blocks of a rewritable non-volatile memory module and a working state of the storage device ; when the working state is a busy state, determining whether to execute a garbage collection operation based on the block usage status and a host write demand ; and when the garbage collection operation is executed during a host write operation, dynamically adjusting a write speed of the host write operation based on the number of remaining blocks. By monitoring the physical block usage status and host write behavior in real-time, combined with a dynamic write speed adjustment mechanism, the method improves the execution efficiency of the garbage collection operation and enhances the write performance of the storage device under high-load conditions.

### CROSS-REFERENCE TO RELATED APPLICATION

This application claims the priority benefit of China application serial no. 202411832055.9, filed on Dec. 12, 2024. The entirety of the above-mentioned patent application is hereby incorporated by reference herein and made a part of this specification.

### BACKGROUND

### Technical Field

The present disclosure relates to the field of memory technology, and more particularly, to a memory management method and a memory controller.

### Description of Related Art

Non-volatile memory refers to a computer memory in which stored data is not lost when power is cut off. It has the advantages of data non-volatility, power saving, small size, and no mechanical structure, and is widely used in various electronic devices.

A common non-volatile memory is a memory configured with flash memory (NAND Flash) (such as a solid state drive), which has the characteristics of high read/write speed and not requiring a mechanical structure for data access.

In existing storage devices, the total number of available physical blocks of a rewritable non-volatile memory module (e.g., NAND flash memory) is fixed. As the host system continuously performs write operations, physical blocks in the storage device are continuously consumed. When the physical blocks are about to be exhausted, the firmware of the storage device must initiate a garbage collection operation to release physical blocks occupied by invalid data. However, to ensure that the release speed of physical blocks is faster than the consumption speed of physical blocks, the storage device must limit the write speed of the host write operation. In the prior art, if the speed at which the garbage collection operation releases physical blocks is slow, the storage device will suddenly limit the host write operation to a lower speed range. The resulting sudden drop in write speed may cause performance stuttering issues in the host system.

### SUMMARY

The present disclosure provides a memory controller and a control method thereof that dynamically adjust a write speed based on a working state of a storage device, a usage status of data blocks, and host behavior dynamics, which may solve the technical problem in the prior art where a sudden decrease in the write speed of the storage device causes performance stuttering in the host system.

One or more embodiments of the present disclosure provide a memory management method, adapted for a storage device configured with a rewritable non-volatile memory module. The method comprises: obtaining a block usage status of a plurality of physical blocks of the rewritable non-volatile memory module; obtaining a working state of the storage device; when the working state of the storage device is a busy state: determining whether to execute a garbage collection operation based on the block usage status of the plurality of physical blocks and a host write demand of the storage device; and when the garbage collection operation is executed during a host write operation, dynamically adjusting a write speed of the host write operation based on a quantity of a plurality of remaining blocks among the plurality of physical blocks.

In one or more embodiments of the present disclosure, the method further comprises: when the storage device is in an idle state, obtaining a first total valid data amount of a plurality of first written physical blocks among the plurality of physical blocks, and determining whether to execute a pre-garbage collection operation based on the first total valid data amount; and when a host write command is received during execution of the pre-garbage collection operation, suspending the pre-garbage collection operation.

In one or more embodiments of the present disclosure, the step of determining whether to execute the pre-garbage collection operation based on the first total valid data amount comprises: obtaining a first valid data ratio between the first total valid data amount and a total storage space of the plurality of first written physical blocks; when the first valid data ratio is less than a first valid data ratio threshold, determining to execute the pre-garbage collection operation, wherein the step of suspending the pre-garbage collection operation comprises: not limiting a write speed of another host write operation corresponding to the host write command.

In one or more embodiments of the present disclosure, the step of determining whether to execute the garbage collection operation based on the block usage status of the plurality of physical blocks and the host write demand of the storage device comprises: obtaining a first total number of a plurality of remaining blocks that have not been written among the plurality of physical blocks; recording a second total number of a plurality of second written physical blocks used from the plurality of remaining blocks; when a ratio of the second total number to the first total number exceeds a usage threshold, determining the host write demand; and if the determined host write demand is a high demand, determining to execute the garbage collection operation; and if the determined host write demand is not the high demand, determining not to execute the garbage collection operation.

In one or more embodiments of the present disclosure, the step of determining the host write demand comprises: obtaining a second total valid data amount of the plurality of second written physical blocks; obtaining a second valid data ratio between the second total valid data amount and a total storage space of the plurality of second written physical blocks; and when the second valid data ratio exceeds a second valid data ratio threshold, determining the host write demand as a high demand.

In one or more embodiments of the present disclosure, the step of executing the garbage collection operation comprises: selecting one or more target GC physical blocks from the plurality of physical blocks, so as to execute the garbage collection operation on the one or more target GC physical blocks, wherein a valid data ratio of each of the target GC physical blocks is less than a GC valid data ratio threshold.

In one or more embodiments of the present disclosure, the step of dynamically adjusting the write speed of the host write operation based on the quantity of the plurality of remaining blocks among the plurality of physical blocks comprises: obtaining a GC write speed of the garbage collection operation; based on the first total number of the plurality of remaining blocks that have not been written among the plurality of physical blocks and the GC write speed, adjusting the current write speed of the host write operation.

In one or more embodiments of the present disclosure, the step of adjusting the current write speed of the host write operation based on the first total number of the plurality of remaining blocks that have not been written among the plurality of physical blocks and the GC write speed comprises: obtaining a first remaining ratio between the first total number and a total number of the plurality of physical blocks; based on the first remaining ratio, adjusting the write speed using the GC write speed.

In one or more embodiments of the present disclosure, the step of adjusting the write speed using the GC write speed based on the first remaining ratio comprises: obtaining a current remaining ratio interval corresponding to the first remaining ratio; based on the remaining ratio interval, determining a corresponding speed adjustment multiplier, wherein a lower remaining ratio interval corresponds to a lower speed adjustment multiplier; and adjusting the write speed using the GC write speed of the garbage collection operation and the speed adjustment multiplier, wherein if the remaining ratio interval is a highest remaining ratio interval, the write speed of the host write operation is not adjusted.

In one or more embodiments of the present disclosure, the step of dynamically adjusting the write speed of the host write operation based on the quantity of the plurality of remaining blocks among the plurality of physical blocks further comprises: when the first total number of the plurality of remaining blocks that have not been written among the plurality of physical blocks reaches a critical remaining quantity, determining the remaining ratio interval as a lowest remaining ratio interval, and executing following steps: selecting one or more target GC physical blocks from the plurality of physical blocks to execute the garbage collection operation on the one or more target GC physical blocks; obtaining a valid data ratio of each of the target GC physical blocks; based on the valid data ratio of the target GC physical block and a target GC write speed corresponding to the target GC physical block, adjusting the write speed of the host write operation.

In one or more embodiments of the present disclosure, the step of adjusting the write speed of the host write operation based on the valid data ratio of the target GC physical block and the target GC write speed corresponding to the target GC physical block comprises: based on a comparison result between the valid data ratio and another GC valid data ratio threshold, determining an emergency speed adjustment multiplier; and adjusting the write speed of the host write operation using the target GC write speed and the emergency speed adjustment multiplier.

In one or more embodiments of the present disclosure, the step of suspending the pre-garbage collection operation further comprises: obtaining a current execution progress of the pre-garbage collection operation; recording interrupt point information corresponding to the current execution progress; and based on the interrupt point information, setting a recovery identifier, wherein when the execution of the host write command is completed, whether to resume executing the pre-garbage collection operation is determined based on the recovery identifier.

In one or more embodiments of the present disclosure, the step of determining the host write demand comprises: setting a sliding time window; within the sliding time window, calculating a cumulative write data amount based on a logical address range of a received host write command; and when the cumulative write data amount exceeds a preset data amount threshold, determining the host write demand as the high demand.

In one or more embodiments of the present disclosure, the step of adjusting the write speed using the GC write speed of the garbage collection operation and the speed adjustment multiplier comprises: obtaining a previous write speed; calculating a speed difference between a current target write speed and the previous write speed; based on the speed difference, determining whether it is necessary to perform a smooth transition; and if it is determined that the smooth transition needs to be performed, gradually adjusting the write speed to the target write speed within a preset transition period.

Based on the above, the memory management method and the memory controller provided by the embodiments of the present disclosure effectively reduce the overhead of centralized collection when physical blocks are nearly exhausted by pre-performing garbage collection based on the amount of valid data when the storage device is idle; make the adjustment of the write speed smoother by utilizing a host write behavior analysis mechanism to predict write demands and implementing a tiered speed limit strategy based on the number of remaining physical blocks; and significantly improve the performance stability of the storage device under high load conditions by dynamically adjusting the speed limit multiplier based on the valid data ratio of the target GC physical block in a critical state, so as to avoid the sudden drop in write speed caused by excessively low garbage collection efficiency.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block schematic diagram of a host system and a storage device according to an embodiment of the present invention.

FIG. 2 is a flowchart of a memory management method according to an embodiment of the present invention.

FIG. 3 is a flowchart for determining a host write demand according to an embodiment of the present invention.

FIG. 4 is a flowchart for dynamically adjusting a write speed according to an embodiment of the present invention.

FIG. 5 is a flowchart for dynamically adjusting a write speed in a critical state according to an embodiment of the present invention.

FIG. 6 is a schematic diagram illustrating the relationship between a speed adjustment multiplier and a remaining ratio according to an embodiment of the present invention.

FIG. 7 is a schematic diagram illustrating the relationship between an emergency speed adjustment multiplier and a valid data ratio according to an embodiment of the present invention.

### DESCRIPTION OF THE EMBODIMENTS

Reference will now be made in detail to the exemplary embodiments of the present disclosure, examples of which are illustrated in the accompanying drawings. Wherever possible, the same component symbols are used in the drawings and the description to refer to the same or similar parts.

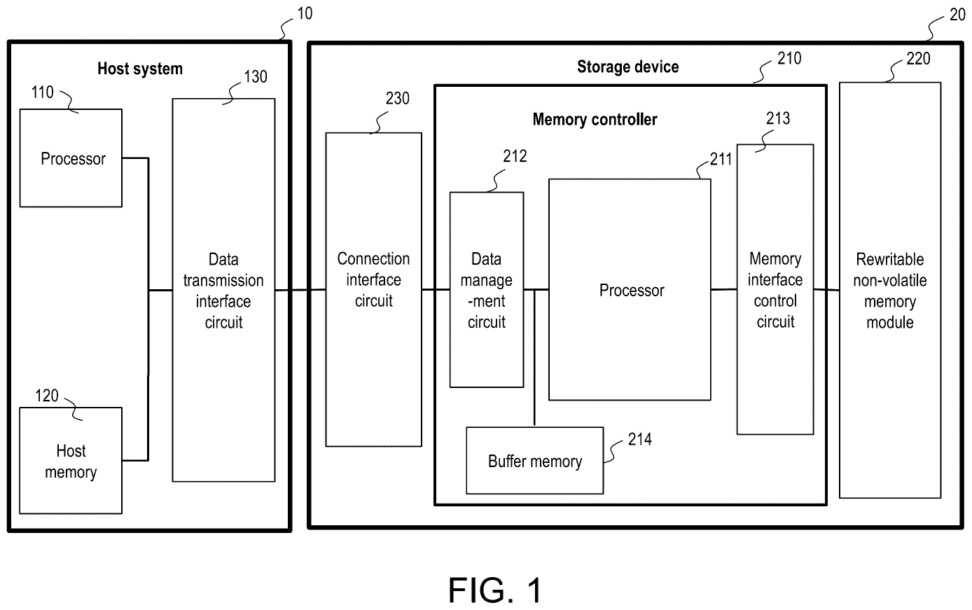

FIG. 1 is a block schematic diagram of a host system and a storage device according to an embodiment of the present disclosure. Please refer to FIG. 1, a host system 10 is, for example, a personal computer, a notebook computer, or a server. The host system 10 comprises a processor 110 (also referred to as a second processor), a host memory 120, and a data transmission interface circuit 130. In this embodiment, the processor 110 is coupled (also referred to as electrically connected) to the host memory 120 and the data transmission interface circuit 130. In another embodiment, the processor 110, the host memory 120, and the data transmission interface circuit 130 are electrically connected to each other using a system bus. In this embodiment, the processor 110, the host memory 120, and the data transmission interface circuit 130 may be disposed on a motherboard of the host system 10.

A storage device 20 comprises a memory controller 210, a rewritable non-volatile memory module 220, and a connection interface circuit 230. The memory controller 210 comprises a processor 211 (also referred to as a first processor), a data management circuit 212, and a memory interface control circuit 213.

In this embodiment, the host system 10 is electrically connected to the storage device 20 through the data transmission interface circuit 130 and the connection interface circuit 230 of the storage device 20 to perform data access operations. For example, the host system 10 may store data to the storage device 20 or read data from the storage device 20 via the data transmission interface circuit 130.

In this embodiment, the number of the data transmission interface circuits 130 may be one or more. Through the data transmission interface circuit 130, a motherboard may be electrically connected to the storage device 20 via a wired or wireless manner. The storage device 20 may be, for example, a USB flash drive, a memory card, a Solid State Drive (SSD), or a wireless memory storage device. The wireless memory storage device may be, for example, a Near Field Communication (NFC) memory storage device, a Wi-Fi memory storage device, a Bluetooth memory storage device, or a Bluetooth Low Energy memory storage device (e.g., iBeacon), or other memory storage devices based on various wireless communication technologies. In addition, the motherboard may also be electrically connected to various I/O devices such as a Global Positioning System (GPS) module, a network interface card, a wireless transmission device, a keyboard, a screen, a speaker, etc., through a system bus.

In this embodiment, the data transmission interface circuit 130 and the connection interface circuit 230 are interface circuits compatible with the Peripheral Component Interconnect Express (PCI Express) standard. Furthermore, data transmission between the data transmission interface circuit 130 and the connection interface circuit 230 is performed using the Non-Volatile Memory express (NVMe) communication protocol.

In addition, in another embodiment, the connection interface circuit 230 may be packaged in a single chip with the memory controller 210, or the connection interface circuit 230 is disposed outside a chip containing the memory controller 210.

In this embodiment, the host memory 120 is for temporarily storing instructions or data executed by the processor 110. For example, in this embodiment, the host memory 120 may be a Dynamic Random Access Memory (DRAM), a Static Random Access Memory (SRAM), or the like. However, it should be understood that the present disclosure is not limited thereto, and the host memory 120 may also be another suitable memory.

The memory controller 210 is for executing a plurality of logic gates or control instructions implemented in a hardware form or a firmware form, and performing operations such as writing, reading, and erasing data in the rewritable non-volatile memory module 220 according to commands from the host system 10.

In more detail, the processor 211 in the memory controller 210 is a hardware with computing capabilities, for controlling the overall operation of the memory controller 210. Specifically, the processor 211 is programmed by a plurality of control instructions/program codes, and when the storage device 20 is operating, these control instructions/program codes are executed to perform operations such as writing, reading, and erasing data. In addition, in this embodiment, the control instructions/program codes may further be executed to implement the memory management method provided by the present disclosure. The control instructions/program codes corresponding to the memory management may further be implemented as circuit units in a hardware form, so as to implement the memory management method provided by the present disclosure.

It is worth mentioning that, in this embodiment, the processor 110 and the processor 211 are, for example, a Central Processing Unit (CPU), a micro-processor, or another programmable processing unit, a Digital Signal Processor (DSP), a programmable controller, an Application Specific Integrated Circuit (ASIC), a Programmable Logic Device (PLD), or other similar circuit components, and the present disclosure is not limited thereto.

In this embodiment, as described above, the memory controller 210 further comprises the data management circuit 212 and the memory interface control circuit 213. It should be noted that operations performed by various components of the memory controller 210 may also be regarded as operations performed by the memory controller 210.

The data management circuit 212 is electrically connected to the processor 211, the memory interface control circuit 213, and the connection interface circuit 230. The data management circuit 212 is for receiving instructions from the processor 211 to perform data transmission. For example, reading data from the host system 10 (e.g., the host memory 120) via the connection interface circuit 230, and writing the read data to the rewritable non-volatile memory module 220 via the memory interface control circuit 213 (e.g., performing a host write operation according to a host write command from the host system 10). As another example, reading data from one or more physical units of the rewritable non-volatile memory module 220 via the memory interface control circuit 213 (data may be read from one or more memory cells in the one or more physical units), and writing the read data to the host system 10 (e.g., the host memory 120) via the connection interface circuit 230 (e.g., performing a read operation according to a read command from the host system 10). In another embodiment, the data management circuit 212 may also be integrated into the processor 211.

The memory interface control circuit 213 is for receiving instructions from the processor 211 and, in coordination with the data management circuit 212, performing a write (also referred to as programming) operation, a read operation, or an erase operation (also referred to as an erase operation) on the rewritable non-volatile memory module 220.

In addition, data to be written to the rewritable non-volatile memory module 220 is converted into a format acceptable to the rewritable non-volatile memory module 220 via the memory interface control circuit 213. Specifically, if the processor 211 is to access the rewritable non-volatile memory module 220, the processor 211 sends a corresponding command sequence to the memory interface control circuit 213 to instruct the memory interface control circuit 213 to execute a corresponding operation. For example, these command sequences may include a write command sequence for instructing to write data, a read command sequence for instructing to read data, an erase command sequence for instructing to erase data, and corresponding command sequences for instructing various memory operations. These command sequences may include one or more signals, or data on a bus. These signals or data may include command codes or program codes. For example, a read command sequence will include information such as a read identifier, a memory address, a physical address, etc.

In the present disclosure, the memory controller 210 establishes a logical-to-physical address mapping table (also referred to as an L2P mapping table) and a physical-to-logical address mapping table (also referred to as a P2L mapping table) to record the mapping relationship between logical addresses of logical units (e.g., logical blocks, logical pages, or logical rows) configured for the rewritable non-volatile memory module 220 and physical addresses of physical units (e.g., physical erase units/physical blocks, physical pages, physical rows). In other words, the memory controller 210 may look up a physical unit mapped by a logical unit (e.g., look up a physical page mapped by a logical page; look up a physical address mapped by a logical address) through the logical-to-physical address mapping table, and the memory controller 210 may look up a logical unit mapped by a physical unit (e.g., look up a logical page mapped by a physical page; look up a logical address mapped by a physical address) through the physical-to-logical address mapping table.

In an embodiment, the memory controller 210 further comprises a buffer memory 214. The buffer memory is electrically connected to the processor 211 and is for temporarily storing data and commands from the host system 10, data from the rewritable non-volatile memory module 220, or other system data for managing the storage device 20 (such as various mapping tables, index tables, block usage status information of physical blocks, various total valid data amounts, various valid data ratios, various remaining ratios, speed adjustment multipliers for each remaining ratio interval, statistics of cumulative write data amount within a sliding time window, interrupt point information and its recovery identifier, and other system data associated with this memory management method), so that the processor 211 may quickly access the data, commands, or system data from the buffer memory 214.

In an embodiment, the memory controller 210 reserves a specific area in the buffer memory 214 for storing various types of mapping tables and index information. The memory controller 210 performs tiered caching of this data based on access frequency and importance: frequently accessed mapping table information is stored in a fast-access area, while less-used information is stored in a normal area. When the space in the buffer memory 214 is insufficient, the memory controller 210 prioritizes writing the less-used information back to the rewritable non-volatile memory module 220. To improve data reliability, the memory controller 210 also periodically synchronizes important mapping information from the buffer memory 214 to the rewritable non-volatile memory module 220 and records synchronization timestamps, so as to be able to recover to the most recent valid state in the event of a system anomaly.

In another embodiment, the memory controller 210 stores these data structures in a preset area of the buffer memory and periodically synchronizes their updated states to the rewritable non-volatile memory module, so as to ensure data persistence and consistency. In some embodiments, when the memory controller 210 restarts, it may recover the latest state of these data structures from the rewritable non-volatile memory module, ensuring that the system can continue previous storage management operations.

The rewritable non-volatile memory module 220 is electrically connected to the memory controller 210 (the memory interface control circuit 213) and is for storing data written by the host system 10.

In this embodiment, the rewritable non-volatile memory module 220 has a plurality of word lines, wherein each of the plurality of word lines is electrically connected to a plurality of memory cells. A plurality of memory cells on the same word line form a physical programming unit (also referred to as a physical page). Each physical page corresponds to a physical address, which is used to record the location of the data stored in the physical page. In addition, a plurality of physical pages may form a physical block (also referred to as a physical erase unit). Each of a plurality of memory dies (chips) of the rewritable non-volatile memory module has a plurality of planes, and each plane has a plurality of physical blocks. It should be noted that the present disclosure does not limit the size of each physical page and logical page.

A memory cell type (also known as storage mode) may be used to represent the number of bits that each memory cell can store. Common types include SLC (Single-Level Cell, storing 1 bit per memory cell), MLC (Multi-Level Cell, storing 2 bits per memory cell), TLC (Triple-Level Cell, storing 3 bits per memory cell), etc. Different storage modes have differences in storage density, read/write speed, and endurance, which affect the overall performance and characteristics of the flash memory.

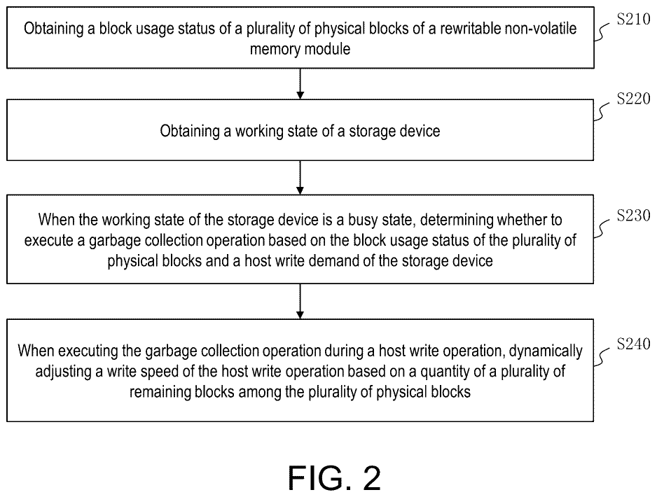

FIG. 2 is a flowchart of a memory management method according to an embodiment of the present invention.

Referring to FIG. 2, in an embodiment, the memory controller 210 executes a memory management method. Specifically, in step S210, the memory controller 210 obtains a block usage status of a plurality of physical blocks of the rewritable non-volatile memory module 220. The memory controller 210 communicates with the rewritable non-volatile memory module 220 through the memory interface control circuit 213 to obtain usage state information of each physical block, including data such as used space, remaining space, and the valid data amount of each data block (written block). This information is cached in the buffer memory 214 for subsequent analysis by the processor 211.

Next, in step S220, the memory controller 210 obtains a working state of the storage device 20.

In an embodiment, the processor 211 monitors whether there are write requests from the host system 10 through the data management circuit 212. If no write request from the host system 10 is received within a predetermined time window, it is determined that the storage device 20 is in an idle state; otherwise, if it is detected that the host system 10 is performing a write operation or waiting to perform a write operation, it is determined that the storage device 20 is in a busy state.

In another embodiment, the processor 211 may also comprehensively consider other factors to determine the working state, for example: a system load level, a current write queue length, and a usage rate of the buffer memory 214.

Next, in step S230, when the working state of the storage device 20 is a busy state, the memory controller 210 determines whether to execute a garbage collection operation based on the block usage status of the plurality of physical blocks and a host write demand.

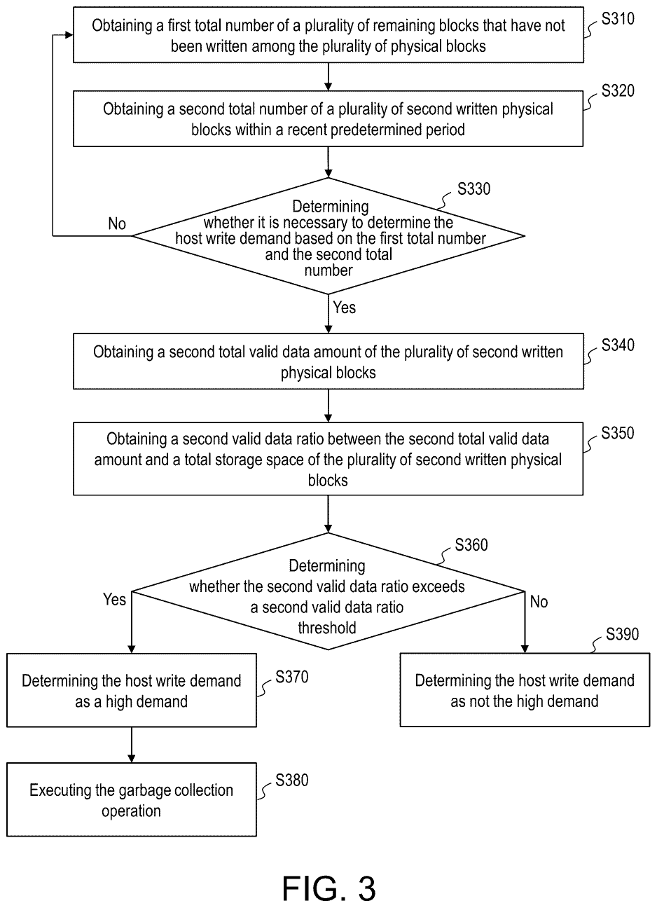

FIG. 3 is a flowchart for determining a host write demand according to an embodiment of the present invention.

Referring to FIG. 3, in an embodiment, the memory controller 210 executes a method for determining a host write demand. When the working state of the storage device 20 is a busy state, the memory controller 210 determines the host write demand according to the following steps, so as to decide whether to execute a garbage collection operation.

In step S310, the processor 211 obtains a first total number of a plurality of remaining blocks that have not been written among a plurality of physical blocks of the rewritable non-volatile memory module 220 through the memory interface control circuit 213. The processor 211 temporarily stores the first total number in the buffer memory 214 for subsequent calculation and determination.

Next, in step S320, the processor 211 obtains a second total number of a plurality of second written physical blocks within a recent predetermined period. Specifically, the processor 211 continuously monitors and records, through the data management circuit 212, the number of physical blocks among the remaining blocks that are actually consumed when the host system 10 performs a write operation during the predetermined period (e.g., the last 100 milliseconds or another duration, to which the present disclosure is not limited). The second total number is also temporarily stored in the buffer memory 214.

Next, in step S330, the processor 211 determines whether it is necessary to determine the host write demand based on the first total number and the second total number. Specifically, the processor 211 calculates a ratio of the second total number to the first total number. When the ratio exceeds a preset usage threshold (e.g., 10% or another predetermined proportion, to which the present disclosure is not limited), it indicates that the consumption speed of physical blocks has been relatively fast in the recent period, and the processor 211 determines that it is necessary to further determine the host write demand (e.g., start executing the operation of determining the host write demand). Otherwise, if the ratio does not exceed the usage threshold, the processor 211 returns to step S310 to continue monitoring the block usage status of the physical blocks.

If it is determined in step S330 that it is necessary to determine the host write demand, the processor 211 obtains a second total valid data amount of the plurality of second written physical blocks in step S340.

In an embodiment, the processor 211 may obtain the second total valid data amount through a real-time counter mechanism. Specifically, when the host system 10 performs a write operation, the processor 211 maintains a valid data counter for each of the second written physical blocks. When new data is written, the counter of the corresponding physical block is incremented by one; when data is overwritten or deleted, the counter of the source physical block is decremented by one, and the counter of the target physical block is incremented by one. The processor 211 may obtain the second total valid data amount by accumulating the values of these counters.

In another embodiment, the processor 211 may obtain the second total valid data amount through a mapping table scanning method. Specifically, the processor 211 maintains a logical-to-physical mapping table in the buffer memory 214, which records whether each physical address stores valid data. By scanning the mapping table, the processor 211 may count the number of mapped addresses in each of the second written physical blocks, so as to calculate the second total valid data amount.

In yet another embodiment, the processor 211 may adopt a hybrid acquisition method. Specifically, a counter is used for real-time statistics during a normal write process, and the count value is periodically corrected through mapping table scanning, so as to improve the accuracy of the statistics of the second total valid data amount.

Next, in step S350, the processor 211 obtains a second valid data ratio between the second total valid data amount and a total storage space of the plurality of second written physical blocks. Specifically, the processor 211 first calculates the total storage space of these second written physical blocks, and then obtains the second valid data ratio by dividing the second total valid data amount by the total storage space.

Next, in step S360, the processor 211 determines whether the second valid data ratio exceeds a second valid data ratio threshold. When the second valid data ratio exceeds a preset threshold (e.g., 90% or another predetermined proportion, to which the present disclosure is not limited), it indicates that the recently written data blocks contain a large amount of valid data. The processor 211 accordingly determines in step S370 that the current host write demand is a high demand, and executes the garbage collection operation in step S380 (this garbage collection operation is executed even if a host write operation is currently being executed).

Otherwise, if the second valid data ratio does not exceed the threshold, the processor 211 determines in step S390 that the host write demand is not a high demand. In this case, the processor 211 may perform the following operations: first, the processor 211 maintains the current host write speed at a relatively high level without initiating a write speed limiting mechanism. Second, the processor 211 may prioritize allocating system resources to the host write operation and postpone the garbage collection operation until the storage device 20 enters an idle state. In this way, the memory controller 210 ensures host write performance.

In an embodiment, when it is determined that the garbage collection operation needs to be executed, the processor 211 selects one or more target GC physical blocks from a plurality of physical blocks. Specifically, the processor 211 obtains a valid data ratio of each physical block and selects physical blocks with a valid data ratio less than a GC valid data ratio threshold (e.g., 30% or another predetermined proportion, to which the present disclosure is not limited) as the target GC physical blocks. By selecting physical blocks with less valid data for garbage collection, the overhead of data movement may be reduced, and the execution efficiency of garbage collection is improved.

Through the aforementioned multi-level determination mechanism based on the block usage status of physical blocks, the memory controller 210 can timely identify high-intensity write behavior of the host system 10 and initiate the garbage collection operation in advance, so as to avoid passively executing garbage collection only when physical block resources are tight. This predictive management method significantly improves the performance of the storage device 20 under high-load conditions.

In some embodiments, the processor 211 may dynamically adjust the aforementioned thresholds based on the actual application scenario of the storage device 20, for example:
(1) The second valid data ratio threshold may be lowered in a high-performance mode. The advantage of lowering the second valid data ratio threshold in the high-performance mode is that the high-performance mode usually has higher requirements for write speed and response time. Lowering the threshold means that even if the proportion of valid data in a data block is relatively low, it will be determined as a high write demand. In this way, lowering the second valid data ratio threshold in the high-performance mode may trigger the garbage collection operation earlier to release physical block resources in advance, so as to avoid being forced to execute garbage collection only when physical block resources are tight, thereby reducing write latency.
(2) The usage threshold may be raised in a low-power mode: The advantage of raising the usage threshold in the low-power mode is that the low-power mode prioritizes reducing system resource consumption. Raising the threshold means that a higher proportion of physical block consumption is required to trigger the garbage collection determination. In this way, raising the usage threshold in the low-power mode may reduce unnecessary garbage collection operations and lower power consumption. In addition, since the performance requirements in the low-power mode are lower, a higher write latency can be tolerated.

In an embodiment, if the processor 211 determines that the host write demand is a high demand, it decides to execute the garbage collection operation. Otherwise, if it is determined that the host write demand is not a high demand, the garbage collection operation is temporarily not executed. Through this determination mechanism based on host write behavior analysis, the memory controller 210 can initiate the garbage collection operation at an appropriate time, effectively balancing storage performance and resource utilization efficiency.

In another embodiment, the processor 211 may use a sliding time window mechanism to determine the host write demand. Specifically, the processor 211 sets a sliding time window of a fixed size (e.g., 100 milliseconds or another predetermined duration, to which the present disclosure is not limited), and the window continuously moves forward over time. Within the time window, the processor 211 records and accumulates a logical address range of each write command sent by the host system 10 to calculate a cumulative write data amount. When the cumulative write data amount exceeds a preset data amount threshold, the processor 211 determines that the current host write demand is a high demand. This determination method based on a sliding time window may accurately reflect the write pressure from the host system 10 within a specific period.

Returning to FIG. 2, next, in step S240, when the garbage collection operation is executed during a host write operation, the memory controller 210 dynamically adjusts a write speed of the host write operation based on a quantity of a plurality of remaining blocks. Specifically, the processor 211 obtains a GC write speed of the garbage collection operation and adjusts the write speed based on a first remaining ratio between a first total number of the remaining blocks and a total number of physical blocks. For example, when the first remaining ratio is in different intervals, the processor 211 adopts different speed adjustment multipliers, wherein a lower remaining ratio interval corresponds to a lower speed adjustment multiplier. If the remaining ratio interval is a lowest remaining ratio interval, the processor 211 further adjusts the write speed based on a valid data ratio of a target GC physical block to ensure a smooth transition of system performance.

Through the above steps, the memory controller 210 can dynamically adjust the write speed based on the host write behavior, effectively avoiding a sudden decrease in the write speed and improving the performance stability of the storage device 20.

In another embodiment, when the storage device 20 is in an idle state (e.g., no write command from the host system 10 has been received for 100 consecutive milliseconds), the memory controller 210 performs preventive garbage collection management. Specifically, the processor 211 first obtains a first total valid data amount of a plurality of first written physical blocks in the rewritable non-volatile memory module 220 through the memory interface control circuit 213. The processor 211 temporarily stores the data amount information in the buffer memory 214.

Subsequently, the processor 211 calculates a first valid data ratio between the first total valid data amount and a total storage space of the plurality of first written physical blocks. Specifically, the processor 211 first obtains a total storage space size of these first written physical blocks, and then obtains the first valid data ratio by dividing the first total valid data amount by the total storage space. When the first valid data ratio is less than a preset first valid data ratio threshold (e.g., 70% or another predetermined proportion, to which the present disclosure is not limited), it indicates that there is a relatively large amount of invalid data in the current storage space, and the processor 211 accordingly determines that it is necessary to execute a pre-garbage collection operation.

During the execution of the pre-garbage collection operation, if the data management circuit 212 receives a write command from the host system 10, the processor 211 immediately suspends the currently executing garbage collection operation. Specifically, the processor 211 records the current execution progress of the garbage collection operation and prioritizes allocating system resources to the host write operation. It is worth noting that, because the garbage collection operation is preventively executed during idle time, when the operation is suspended to process the host write command, the processor 211 does not impose any limitation on the write speed of the host write operation, thereby ensuring that the host write performance is not affected.

When suspending the pre-garbage collection operation, the processor 211 may execute a series of state-saving operations. Specifically, the processor 211 first obtains the current execution progress of the garbage collection operation, including information such as the number of physical blocks that have been processed, the address of the physical block currently being processed, and the processing position within that physical block. Subsequently, the processor 211 records this interrupt point information in the buffer memory 214, and this information may be used for position locating when resuming the garbage collection operation later.

The processor 211 also sets a recovery identifier based on the recorded interrupt point information. Specifically, the recovery identifier comprises a plurality of fields, such as: a currently processed physical block identifier, an offset address of an in-block operation, a completed garbage collection proportion, and a priority of the garbage collection operation. This information is organized into a state description structure and stored in a predetermined area of the buffer memory 214.

When the execution of the host write command is completed, the processor 211 determines whether to resume executing the pre-garbage collection operation based on the recovery identifier. Specifically, the processor 211 first checks whether the storage device 20 has re-entered an idle state, and then evaluates the amount of unfinished garbage collection, and in combination with the current system resource usage, decides whether to immediately resume the garbage collection operation. If the conditions are met, the processor 211 continues to execute the garbage collection operation from the interruption point based on the previously saved interrupt point information, ensuring that the storage space is effectively organized.

This suspension and resumption mechanism enables the memory controller 210 to dynamically switch between the host write operation and the garbage collection operation, which not only ensures the host write performance but also does not lose the progress information of the garbage collection.

Through this preventive garbage collection mechanism, the memory controller 210 can make full use of the system idle time to organize the storage space without affecting the normal write operation of the host system 10, effectively improving the overall performance of the storage device 20.

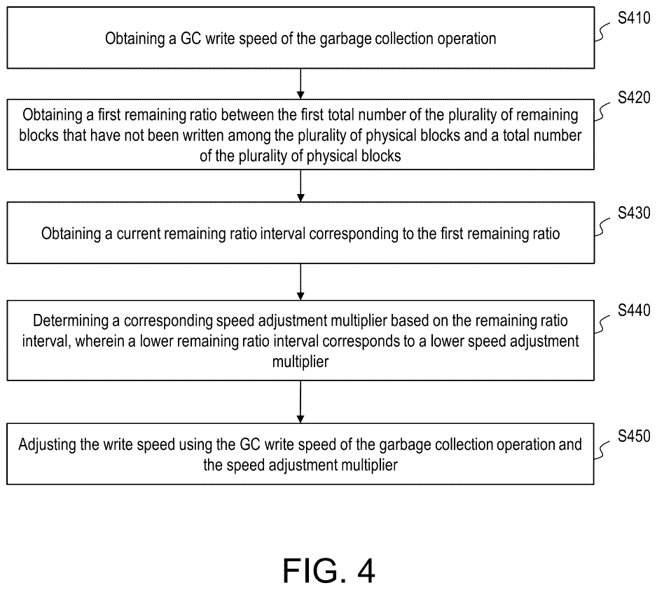

FIG. 4 is a flowchart for dynamically adjusting a write speed according to an embodiment of the present invention.

Referring to FIG. 4, in an embodiment, the memory controller 210 executes a method for dynamically adjusting a write speed. When the garbage collection operation is executed during a host write operation, the processor 211, according to the following steps, dynamically adjusts the write speed of the host write operation based on the quantity of the plurality of remaining blocks among the plurality of physical blocks.

In step S410, the processor 211 obtains a GC write speed of the garbage collection operation. In simple terms, the processor 211 monitors the actual write speed of copying valid data from a source physical block to a target physical block during the garbage collection process through the memory interface control circuit 213.

In an embodiment, the memory controller 210 obtains the GC write speed of the garbage collection operation in the following manner. Specifically, when executing the garbage collection operation, the processor 211 monitors the process of moving data from a source physical block to a target physical block through the memory interface control circuit 213. The processor 211 records the number of bytes of data moved within each preset time interval (e.g., 1 millisecond) and stores this value in the buffer memory 214. By calculating the average number of written bytes over a plurality of consecutive time intervals, the processor 211 may obtain the current actual GC write speed of the garbage collection operation.

In step S420, the processor 211 obtains a first remaining ratio between a first total number of a plurality of remaining blocks that have not been written among a plurality of physical blocks and a total number of the plurality of physical blocks. Specifically, the processor 211 first obtains the total number of physical blocks that have not been written (also referred to as remaining blocks) in the rewritable non-volatile memory module 220 through the memory interface control circuit 213, and then obtains the first remaining ratio by dividing this number by the total number of physical blocks.

In step S430, the processor 211 obtains a current remaining ratio interval corresponding to the first remaining ratio. Specifically, the processor 211 presets a plurality of remaining ratio intervals, for example: 50%-100% is a first interval (also referred to as a highest remaining ratio interval), 30%-50% is a second interval (also referred to as a high remaining ratio interval), 10%-30% is a third interval (also referred to as a medium remaining ratio interval), and less than 10% is a fourth interval (also referred to as a low remaining ratio interval). The processor 211 maps the currently calculated first remaining ratio to one of these preset intervals. It should be noted that the specific settings of the above-mentioned intervals may be varied according to actual needs.

In step S440, the processor 211 determines a corresponding speed adjustment multiplier based on the remaining ratio interval. Specifically, a higher remaining ratio interval corresponds to a higher speed adjustment multiplier. For example, the speed adjustment multiplier corresponding to the first interval is no speed limit, the speed adjustment multiplier corresponding to the second interval is 5× (also referred to as a high speed adjustment multiplier), the speed adjustment multiplier corresponding to the third interval is 3× (also referred to as a medium speed adjustment multiplier), and the speed adjustment multiplier corresponding to the fourth interval is 1.5× (also referred to as a low speed adjustment multiplier). This design ensures that a higher write speed is maintained when the remaining space is sufficient, and the write speed is gradually reduced when the remaining space is insufficient. It should be noted that the above-mentioned values of 5, 3, and 1.5 corresponding to the high speed adjustment multiplier, the medium speed adjustment multiplier, and the low speed adjustment multiplier are exemplary in nature, used to illustrate the relative magnitude relationship, and the present invention is not limited thereto.

In step S450, the processor 211 uses the GC write speed of the garbage collection operation and the speed adjustment multiplier to adjust the write speed. Specifically, if the current first remaining ratio is in the first interval (i.e., the highest remaining ratio interval), the processor 211 does not limit the write speed of the host write operation. If the first remaining ratio is in other intervals, the processor 211 limits the host write speed to within the corresponding multiple of the GC write speed.

Through this multi-level speed limit mechanism based on the number of remaining blocks, the memory controller 210 may reasonably adjust the host write speed under the premise of ensuring stable system operation.

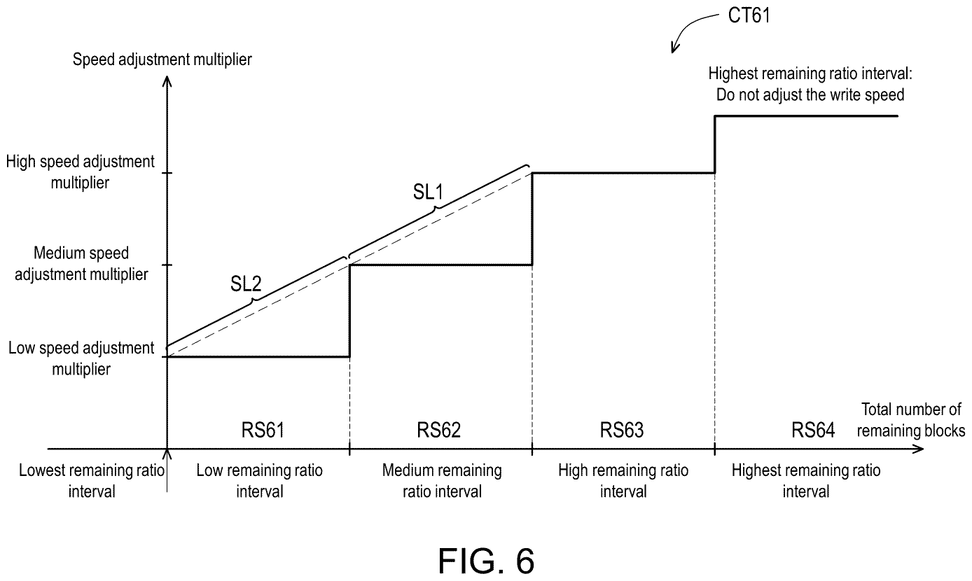

FIG. 6 is a schematic diagram illustrating the relationship between the speed adjustment multiplier and the total number of remaining blocks according to an embodiment of the present invention.

Referring to FIG. 6, in an embodiment, a chart CT61 shows the relationship between the speed adjustment multiplier and the total number of remaining blocks. The horizontal axis represents the total number of remaining blocks, and the axis is divided into a lowest remaining ratio interval (RS61), a medium remaining ratio interval (RS62), a high remaining ratio interval (RS63), and a highest remaining ratio interval (RS64). The vertical axis represents the speed adjustment multiplier.

Specifically, when the total number of remaining blocks is in the highest remaining ratio interval RS64, the processor 211 does not limit the host write speed. When the total number of remaining blocks is in other intervals, the processor 211 limits the host write speed according to the speed adjustment multiplier corresponding to the current interval. Among them, the RS63 interval corresponds to a high speed adjustment multiplier, the RS62 interval corresponds to a medium speed adjustment multiplier, and the RS61 interval corresponds to a low speed adjustment multiplier.

When the total number of remaining blocks reaches a critical remaining quantity, the processor 211 determines that the current interval is the lowest remaining ratio interval RS61. In this case, the processor 211 executes an emergency garbage collection strategy: first, one or more target GC physical blocks (physical blocks used for executing the pre-garbage collection operation) are selected from a plurality of physical blocks. The processor 211 obtains a valid data ratio of each target GC physical block through the memory interface control circuit 213, and calculates an optimal data movement strategy based on this ratio information.

For each target GC physical block, the processor 211 obtains its actual target GC write speed and determines a corresponding write speed limit based on the valid data ratio of the physical block. Specifically, when the valid data ratio of the target GC physical block is relatively low, the processor 211 may adopt a relatively high write speed limit; when the valid data ratio is relatively high, a lower write speed limit is adopted to ensure the reliability of data movement. Through this mechanism, the memory controller 210 may still maintain the stable operation of the system in an emergency situation.

In an embodiment, when the processor 211 adjusts the write speed based on the valid data ratio of the target GC physical block, the following steps are specifically executed. The processor 211 first compares the valid data ratio of the target GC physical block with a preset another GC valid data ratio threshold (e.g., 50% or another predetermined proportion, to which the present disclosure is not limited). Specifically, if the valid data ratio of the target GC physical block is lower than the threshold, the processor 211 sets the emergency speed adjustment multiplier to, for example, 1×, which indicates that the amount of valid data in the current target GC physical block is small, and the garbage collection operation can be completed relatively quickly. For example, after one physical block is released by the pre-garbage collection operation, the host write data can fill up one empty physical block.

Otherwise, if the valid data ratio exceeds the threshold, the processor 211 sets the emergency speed adjustment multiplier to, for example, between 2× and 3×, to cope with a larger amount of data movement. For example, after one physical block is released by the pre-garbage collection operation, the host write data may fill up 2 to 3 physical blocks, so as to slow down the decline of the host write speed. Subsequently, the processor 211 uses the product of the target GC write speed and the determined emergency speed adjustment multiplier to set the write speed limit for the host write operation.

It is worth mentioning that the slanted lines SL1 and SL2 in FIG. 6 represent a smooth transition mechanism. In this embodiment, the processor 211 may use a linear interpolation method to calculate the speed adjustment multiplier at the boundary of adjacent intervals to avoid sudden changes in the write speed when switching between intervals.

In more detail, in an embodiment, to avoid sudden changes in the write speed, the processor 211 implements a smooth transition mechanism. Specifically, when it is necessary to adjust the write speed, the processor 211 first obtains the value of the previous write speed from the buffer memory 214. The processor 211 then calculates a speed difference between the current target write speed and the previous write speed. When the difference exceeds a preset threshold (e.g., the current speed change exceeds 30% of the previous speed or another predetermined proportion), the processor 211 determines that it is necessary to perform a smooth transition.

When performing the smooth transition, the processor 211 gradually adjusts the write speed from the previous value to the target write speed within a preset transition period (e.g., 10 milliseconds or another predetermined time). Specifically, the processor 211 evenly distributes the speed difference into a plurality of adjustment steps, with each adjustment step having the same time interval, thereby achieving a linear transition of the write speed. This smooth transition mechanism may avoid drastic fluctuations in the write speed.

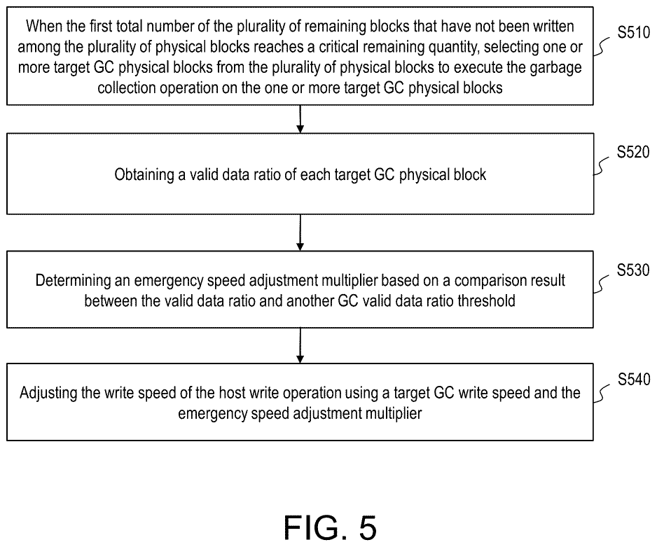

FIG. 5 is a flowchart for dynamically adjusting a write speed in a critical state according to an embodiment of the present invention.

Referring to FIG. 5, in an embodiment, when a first total number of a plurality of remaining blocks that have not been written among a plurality of physical blocks reaches a critical remaining quantity (e.g., 3), the memory controller 210 executes a special write speed adjustment process. It should be noted that the specific value of the critical remaining quantity may be determined according to needs.

In step S510, the processor 211 selects one or more target GC physical blocks from the plurality of physical blocks to execute a garbage collection operation on these physical blocks. Specifically, the processor 211 scans the usage state of all physical blocks through the memory interface control circuit 213 and prioritizes selecting physical blocks with a lower valid data ratio as the target GC physical blocks.

In step S520, the processor 211 obtains a valid data ratio of each target GC physical block. The processor 211 reads the valid data distribution information in these physical blocks through the memory interface control circuit 213 and calculates the actual ratio of the valid data in each target GC physical block relative to the storage space of each target GC physical block.

In step S530, the processor 211 determines an emergency speed adjustment multiplier based on a comparison result between the valid data ratio and another GC valid data ratio threshold. Specifically, if the valid data ratio of the target GC physical block is relatively low, a larger speed adjustment multiplier is adopted; if the valid data ratio is relatively high, a smaller speed adjustment multiplier is adopted to avoid an excessive decrease in the write speed.

In step S540, the processor 211 uses a target GC write speed and the emergency speed adjustment multiplier to adjust the write speed of the host write operation. Through this dynamic adjustment mechanism based on the valid data ratio, the memory controller 210 may still maintain a reasonable write performance in a critical state.

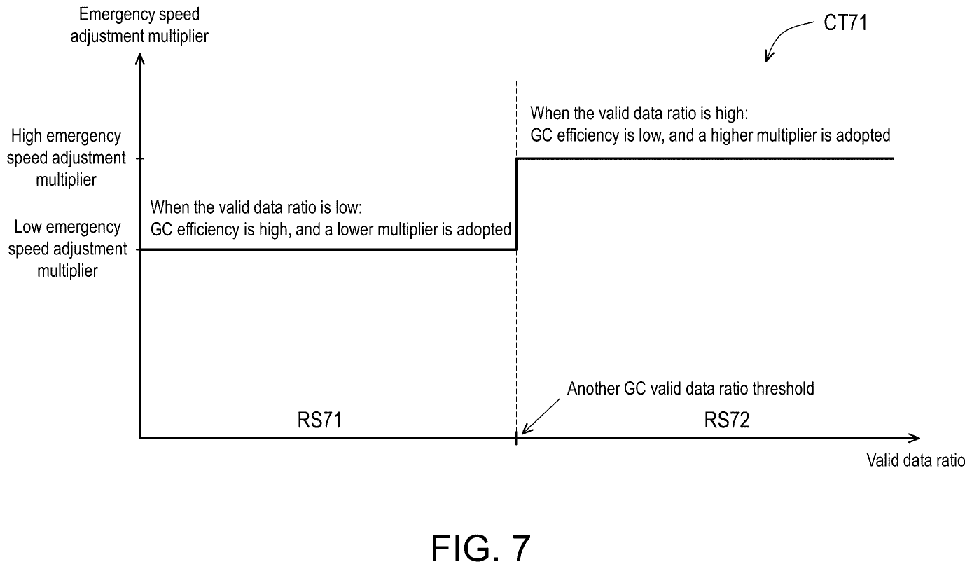

FIG. 7 is a schematic diagram illustrating the relationship between the emergency speed adjustment multiplier and the valid data ratio according to an embodiment of the present invention.

Referring to FIG. 7, a chart CT71 shows the relationship between the emergency speed adjustment multiplier and the valid data ratio in a critical state. The horizontal axis represents the valid data ratio of a target GC physical block, and the horizontal axis is divided into two regions, RS71 and RS72, by another GC valid data ratio threshold. The vertical axis represents the corresponding emergency speed adjustment multiplier.

When the valid data ratio of the target GC physical block is in the RS71 region (i.e., less than another GC valid data ratio threshold), it indicates that the efficiency of the garbage collection operation is relatively high. At this time, the processor 211 adopts a lower emergency speed adjustment multiplier (e.g., 1×), because each garbage collection operation can release new free blocks more quickly.

Conversely, when the valid data ratio is in the RS72 region (i.e., exceeding another GC valid data ratio threshold), it indicates that the garbage collection operation needs to move a large amount of valid data, and the efficiency is relatively low. At this time, the processor 211 adopts a higher emergency speed adjustment multiplier (e.g., 2 to 3×) to give the garbage collection operation more execution time and avoid drastic fluctuations in the write speed.

Through this differentiated adjustment mechanism based on the valid data ratio, the memory controller 210 can still maintain the stable operation of the system in a critical state.

Finally, the present embodiment also provides a computer program product, comprising computer-readable code, or a non-volatile computer-readable storage medium carrying computer-readable code. When the computer-readable code is run on a processor of a host system, the processor 211 executes the steps of the aforementioned memory management method and implements the functions of the memory controller 210. The computer program product may be specifically implemented by hardware, firmware, software, or a combination thereof. In an optional embodiment, the computer program product is specifically embodied as a computer storage medium, and in another optional embodiment, the computer program product is specifically embodied as a software product, such as a Software Development Kit (SDK), etc.

Based on the above, the memory management method and the memory controller provided by the embodiments of the present disclosure can achieve the following technical effects:

First, by pre-executing a garbage collection operation based on the first valid data ratio when the storage device 20 is idle, and timely suspending the operation upon receiving a host write command, the collection pressure on the storage device 20 under high-load conditions is reduced. Specifically, the processor 211, by recording interrupt point information and setting a recovery identifier, ensures that the garbage collection operation can be resumed at an appropriate time, effectively balancing storage performance and resource utilization.

Second, based on a host write behavior analysis mechanism, the processor 211 can identify write demands early and predict resource consumption trends. The processor 211 achieves an accurate assessment of the host write demand by monitoring the block usage status of physical blocks and the valid data ratio within a predetermined period, or in combination with the cumulative write data amount within a sliding time window.

Third, by implementing a multi-level speed limit strategy based on the number of remaining physical blocks, sudden changes in the write speed are avoided. The processor 211 makes the adjustment of the write speed smoother by presetting a plurality of remaining ratio intervals and corresponding speed adjustment multipliers, and by adopting a multi-stage transition mechanism when switching between intervals.

Fourth, in a critical state, a differentiated adjustment mechanism based on the valid data ratio is adopted. The processor 211 avoids the problem of a sharp performance drop caused by excessively limiting the write speed by evaluating the valid data ratio of the target GC physical block and selecting an appropriate emergency speed adjustment multiplier.

Fifth, an intelligent and smooth adjustment of the write speed is achieved. The processor 211 improves the operational stability of the storage device by calculating the difference between the target write speed and the previous write speed, and initiating a smooth transition mechanism when needed to ensure that the write speed is gradually adjusted to the target value within a preset transition period.

Through the above technical solutions, the memory management method provided by the present disclosure significantly improves the performance of the storage device under various load conditions, and is particularly suitable for application scenarios that require frequent data writing.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method, adapted for a storage device configured with a rewritable
non-volatile memory module, wherein the method comprises:
obtaining a block usage status of a plurality of physical blocks of the rewritable non-volatile memory module;
when the storage device is in a busy state, determining whether to execute a garbage collection operation based on the block usage status of the plurality of physical blocks and a host write demand of the storage device; and
when the garbage collection operation is executed during a host write operation, dynamically adjusting a write speed of the host write operation based on a quantity of remaining blocks among the plurality of physical blocks.

2. The memory management method as claimed in claim 1, wherein the method further comprises:
when the storage device is in an idle state, obtaining a first total valid data amount of a plurality of first written physical blocks among the plurality of physical blocks, and determining whether to execute a pre-garbage collection operation based on the first total valid data amount; and
when a host write command is received during execution of the pre-garbage collection operation, suspending the pre-garbage collection operation.

3. The memory management method as claimed in claim 2, wherein step of determining whether to execute the pre-garbage collection operation based on the first total valid data amount comprises:
obtaining a first valid data ratio between the first total valid data amount and a total storage space of the plurality of first written physical blocks;
when the first valid data ratio is less than a first valid data ratio threshold, determining to execute the pre-garbage collection operation.

4. The memory management method as claimed in claim 1, wherein step of determining whether to execute the garbage collection operation based on the block usage status of the plurality of physical blocks and the host write demand of the storage device comprises:
obtaining a first total number of a plurality of remaining blocks that have not been written among the plurality of physical blocks;
recording a second total number of a plurality of second written physical blocks used from the plurality of remaining blocks;
when a ratio of the second total number to the first total number exceeds a usage threshold, determining the host write demand; and
if the determined host write demand is a high demand, determining to execute the garbage collection operation.

5. The memory management method as claimed in claim 4, wherein step of determining the host write demand comprises:
obtaining a second total valid data amount of the plurality of second written physical blocks;
obtaining a second valid data ratio between the second total valid data amount and a total storage space of the plurality of second written physical blocks; and
when the second valid data ratio exceeds a second valid data ratio threshold, determining the host write demand as a high demand.

6. The memory management method as claimed in claim 5, wherein step of executing the garbage collection operation comprises:
selecting one or more target GC physical blocks from the plurality of physical blocks, so as to execute the garbage collection operation on the one or more target GC physical blocks, wherein a valid data ratio of each of the target GC physical blocks is less than a GC valid data ratio threshold.

7. The memory management method as claimed in claim 1, wherein step of dynamically adjusting the write speed of the host write operation based on the quantity of the plurality of remaining blocks among the plurality of physical blocks comprises:
obtaining a GC write speed of the garbage collection operation;
based on the first total number of the plurality of remaining blocks that have not been written among the plurality of physical blocks and the GC write speed, adjusting the current write speed of the host write operation.

8. The memory management method as claimed in claim 7, wherein step of adjusting the current write speed of the host write operation based on the first total number of the plurality of remaining blocks that have not been written among the plurality of physical blocks and the GC write speed comprises:
obtaining a first remaining ratio between the first total number and a total number of the plurality of physical blocks;
based on the first remaining ratio, adjusting the write speed using the GC write speed.

9. The memory management method as claimed in claim 8, wherein step of adjusting the write speed using the GC write speed based on the first remaining ratio comprises:
obtaining a current remaining ratio interval corresponding to the first remaining ratio;
based on the remaining ratio interval, determining a corresponding speed adjustment multiplier, wherein a lower remaining ratio interval corresponds to a lower speed adjustment multiplier; and
adjusting the write speed using the GC write speed of the garbage collection operation and the speed adjustment multiplier.

10. The memory management method as claimed in claim 9, wherein the step of dynamically adjusting the write speed of the host write operation based on the quantity of the plurality of remaining blocks among the plurality of physical blocks further comprises:
when the first total number of the plurality of remaining blocks that have not been written among the plurality of physical blocks reaches a critical remaining quantity, determining the remaining ratio interval as a lowest remaining ratio interval, and executing following steps:
selecting one or more target GC physical blocks from the plurality of physical blocks to execute the garbage collection operation on the one or more target GC physical blocks;
obtaining a valid data ratio of each of the target GC physical blocks;
based on the valid data ratio of the target GC physical block and a target GC write speed corresponding to the target GC physical block, adjusting the write speed of the host write operation.

11. The memory management method as claimed in claim 10, wherein step of adjusting the write speed of the host write operation based on the valid data ratio of the target GC physical block and the target GC write speed corresponding to the target GC physical block comprises:
based on a comparison result between the valid data ratio and another GC valid data ratio threshold, determining an emergency speed adjustment multiplier; and
adjusting the write speed of the host write operation using the target GC write speed and the emergency speed adjustment multiplier.

12. The memory management method as claimed in claim 2, wherein step of suspending the pre-garbage collection operation further comprises:
obtaining a current execution progress of the pre-garbage collection operation;
recording interrupt point information corresponding to the current execution progress; and
based on the interrupt point information, setting a recovery identifier,
wherein when the execution of the host write command is completed, whether to resume executing the pre-garbage collection operation is determined based on the recovery identifier.

13. The memory management method as claimed in claim 4, wherein step of determining the host write demand comprises:
setting a sliding time window;
within the sliding time window, calculating a cumulative write data amount based on a logical address range of a received host write command; and
when the cumulative write data amount exceeds a preset data amount threshold, determining the host write demand as the high demand.

14. The memory management method as claimed in claim 9, wherein step of adjusting the write speed using the GC write speed of the garbage collection operation and the speed adjustment multiplier comprises:
obtaining a previous write speed;
calculating a speed difference between a current target write speed and the previous write speed;
based on the speed difference, determining whether it is necessary to perform a smooth transition; and
if it is determined that the smooth transition needs to be performed, gradually adjusting the write speed to the target write speed within a preset transition period.

15. A memory controller for controlling a storage device configured with a rewritable non-volatile memory module, wherein the memory controller comprises:
a memory interface control circuit, for electrically connecting to the rewritable non-volatile memory module;
a data management circuit, electrically connected to a connection interface circuit of the storage device, for receiving data and commands from a host system via the connection interface circuit;
a buffer memory, for buffering data; and
a processor, electrically connected to the memory interface control circuit, the data management circuit, and the buffer memory, wherein the processor is configured to:
obtain a block usage status of a plurality of physical blocks of the rewritable non-volatile memory module;
when the storage device is in a busy state, determine whether to execute a garbage collection operation based on the block usage status of the plurality of physical blocks and a host write demand of the storage device; and
when the garbage collection operation is executed during a host write operation, dynamically adjust a write speed of the host write operation based on a quantity of remaining blocks among the plurality of physical blocks.

16. The memory controller as claimed in claim 15, wherein the processor is further configured to:
when the storage device is in an idle state, obtain a first total valid data amount of a plurality of first written physical blocks among the plurality of physical blocks, and determine whether to execute a pre-garbage collection operation based on the first total valid data amount; and
when a host write command is received during execution of the pre-garbage collection operation, suspend the pre-garbage collection operation.

17. The memory controller as claimed in claim 16, wherein step of determining whether to execute the pre-garbage collection operation based on the first total valid data amount comprises:
obtaining a first valid data ratio between the first total valid data amount and a total storage space of the plurality of first written physical blocks;
when the first valid data ratio is less than a first valid data ratio threshold, determining to execute the pre-garbage collection operation.

18. The memory controller as claimed in claim 15, wherein step of determining whether to execute the garbage collection operation based on the block usage status of the plurality of physical blocks and the host write demand of the storage device comprises:
obtaining a first total number of a plurality of remaining blocks that have not been written among the plurality of physical blocks;
recording a second total number of a plurality of second written physical blocks used from the plurality of remaining blocks;
when a ratio of the second total number to the first total number exceeds a usage threshold, determining the host write demand; and
if the determined host write demand is a high demand, determining to execute the garbage collection operation.

19. The memory controller as claimed in claim 18, wherein step of determining the host write demand comprises:
obtaining a second total valid data amount of the plurality of second written physical blocks;
obtaining a second valid data ratio between the second total valid data amount and a total storage space of the plurality of second written physical blocks; and
when the second valid data ratio exceeds a second valid data ratio threshold, determining the host write demand as a high demand.

20. The memory controller as claimed in claim 19, wherein step of executing the garbage collection operation comprises:
selecting one or more target GC physical blocks from the plurality of physical blocks, so as to execute the garbage collection operation on the one or more target GC physical blocks, wherein a valid data ratio of each of the target GC physical blocks is less than a GC valid data ratio threshold.

21. The memory controller as claimed in claim 15, wherein step of dynamically adjusting the write speed of the host write operation based on the quantity of the plurality of remaining blocks among the plurality of physical blocks comprises:
obtaining a GC write speed of the garbage collection operation;
based on the first total number of the plurality of remaining blocks that have not been written among the plurality of physical blocks and the GC write speed, adjusting the current write speed of the host write operation.

22. The memory controller as claimed in claim 21, wherein step of adjusting the current write speed of the host write operation based on the first total number of the plurality of remaining blocks that have not been written among the plurality of physical blocks and the GC write speed comprises:
obtaining a first remaining ratio between the first total number and a total number of the plurality of physical blocks;
based on the first remaining ratio, adjusting the write speed using the GC write speed.

23. The memory controller as claimed in claim 22, wherein step of adjusting the write speed using the GC write speed based on the first remaining ratio comprises:
obtaining a current remaining ratio interval corresponding to the first remaining ratio;
based on the remaining ratio interval, determining a corresponding speed adjustment multiplier, wherein a lower remaining ratio interval corresponds to a lower speed adjustment multiplier; and
adjusting the write speed using the GC write speed of the garbage collection operation and the speed adjustment multiplier.

24. The memory controller as claimed in claim 23, wherein the step of dynamically adjusting the write speed of the host write operation based on the quantity of the plurality of remaining blocks among the plurality of physical blocks further comprises:
when the first total number of the plurality of remaining blocks that have not been written among the plurality of physical blocks reaches a critical remaining quantity, determining the remaining ratio interval as a lowest remaining ratio interval, and executing following steps:
selecting one or more target GC physical blocks from the plurality of physical blocks to execute the garbage collection operation on the one or more target GC physical blocks;
obtaining a valid data ratio of each of the target GC physical blocks;
based on the valid data ratio of the target GC physical block and a target GC write speed corresponding to the target GC physical block, adjusting the write speed of the host write operation.

25. The memory controller as claimed in claim 24, wherein step of adjusting the write speed of the host write operation based on the valid data ratio of the target GC physical block and the target GC write speed corresponding to the target GC physical block comprises:
based on a comparison result between the valid data ratio and another GC valid data ratio threshold, determining an emergency speed adjustment multiplier; and
adjusting the write speed of the host write operation using the target GC write speed and the emergency speed adjustment multiplier.

26. The memory controller as claimed in claim 16, wherein step of suspending the pre-garbage collection operation further comprises:
obtaining a current execution progress of the pre-garbage collection operation;
recording interrupt point information corresponding to the current execution progress; and
based on the interrupt point information, setting a recovery identifier,
wherein when the execution of the host write command is completed, whether to resume executing the pre-garbage collection operation is determined based on the recovery identifier.

27. The memory controller as claimed in claim 18, wherein step of determining the host write demand comprises:
setting a sliding time window;
within the sliding time window, calculating a cumulative write data amount based on a logical address range of a received host write command; and
when the cumulative write data amount exceeds a preset data amount threshold, determining the host write demand as the high demand.

28. The memory controller as claimed in claim 23, wherein step of adjusting the write speed using the GC write speed of the garbage collection operation and the speed adjustment multiplier comprises:
obtaining a previous write speed;
calculating a speed difference between a current target write speed and the previous write speed;
based on the speed difference, determining whether it is necessary to perform a smooth transition; and
if it is determined that the smooth transition needs to be performed, gradually adjusting the write speed to the target write speed within a preset transition period.
